(19) United States
(12) Patent Application Publication
(10) Pub. No.: US 2018/0114250 A1
(43) Pub. Date: Apr. 26, 2018

(54) PROMOTING STORE ITEMS USING AUGMENTED REALITY GAMING APPLICATIONS

(71) Applicant: Wal-Mart Stores, Inc., Bentonville, AR (US)

(72) Inventors: Mary Ann Phillips, Bella Vista, AR (US); Michael Morrison, Bella Vista, AR (US); Hang Reusch, Bentonville, AR (US); Justin Reusch, Bentonville, AR (US)

(21) Appl. No.: 15/728,952

(22) Filed: Oct. 10, 2017

Related U.S. Application Data
(60) Provisional application No. 62/411,187, filed on Oct. 21, 2016.

(51) Int. Cl. G06Q 30/02; G06K 7/10; G06Q 30/06; G06Q 50/00; A63F 13/61; A63F 13/335; A63F 13/327

(52) U.S. Cl. CPC G06Q 30/0261; G06K 7/10762; G06Q 30/0633; A63F 13/327; A63F 13/61; A63F 13/335; G06Q 50/01

(57) ABSTRACT

A system and method are provided for promoting store items at a retail environment that electronically pair an augmented-reality gaming application executed on a mobile electronic device with a shopping cart; determine a location of the shopping cart; establishing an electronic communication between the gaming application and the shopping cart during a shopping cart user's presence in the retail environment; receive data at the mobile electronic device pertaining to a store item promotion in response to determining the location of the shopping cart; and apply information regarding the location of the shopping cart to the gaming application.

### RELATED APPLICATIONS

This application claims the benefit of U.S. Provisional Patent No. 62/411,187, filed Oct. 21, 2016, entitled “Promoting Store Items Using Augmented Reality Gaming Applications,” the contents of which are incorporated by reference herein in their entirety.

### TECHNICAL FIELD

The present inventive concepts relate generally to a media-enhanced interactive retail environment, and more specifically, to the overlay of electronic gaming applications on a customer shopping experience that includes an exchange of information between electronic devices in a store.

### BACKGROUND

In an ongoing effort to increase revenues, retail stores continue to develop new approaches and creative offerings to retain customers during a shopping experience.

### SUMMARY

In one aspect, provided is a method for promoting store items at a retail environment, comprising: electronically pairing an augmented-reality gaming application, executed on a mobile electronic device with a shopping cart; determining a location of the shopping cart; establishing an electronic communication between the gaming application and the shopping cart during a shopping cart user's presence in the retail environment; receiving data at the mobile electronic device pertaining to a store item promotion in response to determining the location of the shopping cart; and applying information regarding the location of the shopping cart to the gaming application.

In some embodiments, determining the location of the shopping cart includes: detecting, by a detection device at the retail environment, the shopping cart; reporting, by the detection device, to a store computer the location of the shopping cart; and outputting, by the store computer, information relevant a region of the retail environment that includes the location of the shopping cart.

In some embodiments, the shopping cart includes an Internet of Things (IoT) device that provides a combination of wireless fidelity (WiFi), geofencing, and an infrared (IR) beacon.

In some embodiments, the IoT device further includes a digital scale.

In some embodiments, pairing the application and the shopping cart comprises scanning a QR code on the shopping cart that identifies the shopping cart.

In some embodiments, detecting the shopping cart by establishing a communication between beacons at the retail environment and a receiving tag at the shopping cart.

In some embodiments, detecting the shopping cart includes broadcasting by the beacons an infrared (IR) or radio frequency identification (RFID) signal for receipt by the receiving tag at the shopping cart.

In some embodiments, detecting the shopping cart includes: establishing an electronic communication between a promotional display at the retail establishment and the shopping cart; and receiving promotional feature data at the mobile electronic device.

In some embodiments, the retail establishment includes a location beacon device, and the method further comprises: scanning for the shopping cart when the shopping cart is within a predetermined distance from the location beacon device; notifying by the location beacon device a store server when the cart has entered a geofence or other electronically formed perimeter establishing the predetermined distance; sending by the server a promotional message to the linked mobile device that corresponds to the location beacon device; and prompting the user with the promotional message.

In some embodiments, a shareable social media image is used by the gaming application to generate the promotional message.

In some embodiments, the method further comprises providing coupons to the application while the game is being played.

In some embodiments, the game is used to provide a reward.

In some embodiments, the method further comprises executing a shopping list electronically prior to executing the gaming application.

In some embodiments, the shopping list is entered to the application or retrieved by the mobile electronic device from a remote storage location.

In one aspect, provided is a virtual promotion generation system, comprising: an application executed by a mobile electronic device; and a shopping cart electronically paired with the application so that in response to the pairing, promotion data is provided to the mobile electronic device.

In some embodiments, the shopping cart comprises a quick response (QR) code that identifies the shopping cart.

In some embodiments, the shopping cart further comprises an infrared (IR) or radio frequency identification (RFID) tag that establishes a location of the shopping cart, such that when the QR is scanned for the cart, the user's device reports the cart number to a store server, wherein the store server keeps a database of cart/device pairings. And wherein a beacon actively scans and detects the IR/RFID tag and reports nearby carts to the server, and wherein the store server knows which device is nearby from the database.

In some embodiments, the shopping cart comprises a digital scale to weigh items when scanned to the digital shopping cart.

In some embodiments, the application communicates with a Wi-Fi network for receiving the promotion data.

In some embodiments, the system further comprises a digital shopping list executed at the mobile electronic device.

In some embodiments, the gaming application permits a user to search for items of interest as a game objective, wherein the pairing includes a navigation feature that guides the user to promoted items during the game play.

### BRIEF DESCRIPTION OF THE DRAWINGS

FIG. 1 is a block diagram of electronic components of an environment at which a virtual promotion of store items may be performed, in accordance with some embodiments.

FIG. 2 is a flow diagram of elements of a system for promoting store items, in accordance with some embodiments.

FIG. 3 is a detailed flow diagram of elements of a system for promoting store items, in accordance with some embodiments.

FIG. 4 is a screenshot of a virtual badge used in an electronic game used to promote store items, in accordance with some embodiments.

FIG. 5 is a screenshot a virtual badge in connection with a customer profile stored electronically by a store promoting items of interest, in accordance with some embodiments.

FIG. 6 is a screenshot of a gaming application and location feature displayed for a customer who searches for items of interest as part of the gaming application, in accordance with some embodiments.

FIG. 7 is a screenshot of a shareable social media used by a gaming application to generate a promotional message, in accordance with some embodiments.

### DETAILED DESCRIPTION OF EMBODIMENTS OF THE INVENTION

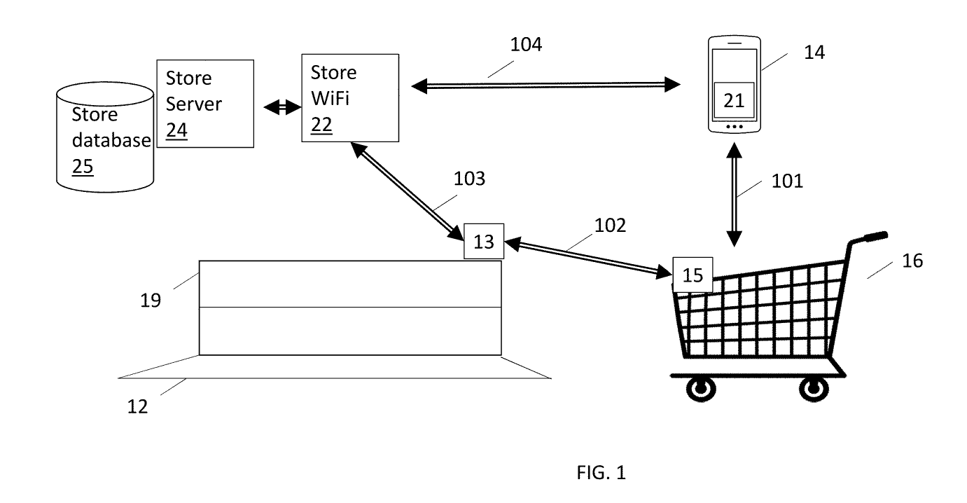

FIG. 1 is a block diagram of electronic components of an environment at which a virtual promotion of store items may be performed, in accordance with some embodiments.

A store customer's mobile device 14 is paired (101) with a shopping cart 16 or the like that is equipped with an Internet of Things (IoT) device 15. The pairing communication permits the mobile device 14 to be located. Pairing can be achieved by using the mobile device 14 to scan a quick response (QR) code, barcode, or other cart identification device on the shopping cart 16. Data related to the linking between device 14 and cart 16 may be stored at the database 25. When the beacon 13 senses a cart, it sends that cart ID to the server 24. The server 24 looks up which device paired with that cart ID and sends the message to that device 14. For example, beacon 13 is in the cereal aisle and sees cart 16. It sends a message to the server 24 that cart 16 has been detected. The server 24 finds that cart 16 is paired with mobile device 14. It sends a message related to cereal to mobile device 14.

The shopping cart 16 may also be equipped with an infrared (IR) or radio frequency identification (RFID) tag or the like so that aisle beacons 13 can detect when the shopping cart 16 is within a predetermined proximity of the beacon 13. The shopping cart 16 may include other accessories such as a digital scale or other IoT device for weighing items.

The mobile device 14 may be a smartphone, computer tablet, or other handheld or mobile device including a processor, memory, network interface, and peripheral device such as a display, audio speaker, and so on. The mobile device 14 may execute a store application 21 that permits the mobile device 14 to communicate with the store Wi-Fi network 22 and to pair with the shopping cart 16, or more specifically, the IoT device 15 or related electronic processing device at the shopping cart 16. This permits the device 14 location to be known using Wi-Fi geofencing, GPS, triangulation, and/or other location detection technique. In addition to pairing with the shopping cart 16, the mobile device 14 may communicate with a store point of sale system, fast checkout counter, store website, and/or other store-related electronic systems.

The pairing permits the mobile device 14 to receive (104) relevant data via the store's Wi-Fi network 22. Electronic communication devices such as infrared (IR) or radio frequency identification (RFID) beacons may be located at shelves (e.g., 19), aisle endcaps, aisles, and/or other store locations for detecting the shopping cart 16. Aisle beacons 13 can report (103) a location of nearby carts 16 back to the store server 24. The IoT device 15 of the shopping cart 16 may include a built-in IR or RFID tag for receiving (102) such signals. This communication between the mobile device 14, store WiFI network 22, and shopping cart 16 allows the store computer 24 to locate the cart 16, and by extension also the mobile device 14 due to the pairing. This feature permits the customer to enjoy navigational functions while also providing the customer with access to promotion-related information, product information, and/or other information, e.g., from the store server 24, that may improve or enhance the shopper's experience at the store. Therefore, store customers provide more interaction with respect to items of interest, especially items that are being promoted, than merely perusing items stored on shelves due to the customer receiving an increased amount of promotion due to the customer's location in a store. The store computer 24, in turn, can collect customer shopping pattern information for performing analytics or other reasons.

For example, wireless communications, such as IR/RFID and/or geofencing, may provide for a beacon 13 to scan for and locate any shopping cart that enters a certain proximity, e.g., ˜3 feet. When the beacon 13 detects the cart 16 within a predetermined range, it reports to the central server 24 that the cart 16 has entered the geofence, WiFi region, or other electronic communication perimeter within proximity of the beacon 13. The server 24 then sends the promotional message to the linked device 14 that corresponds to that beacon 13. The customer is prompted with the promotion, but has to select it on the device 14 to take advantage of the promotional data available due to the pairing. The message may be canceled, or otherwise communication can be broken, when the cart 16 leaves the predefined region, e.g., geofence area.

The shopping cart 16 may comprise an IR or RFID tag that establishes a location of the shopping cart 16, such that when the QR is scanned for the cart, the user's device reports the cart number to a store server, wherein the store server keeps a database of cart/device pairings. And wherein a beacon 13 actively scans and detects the IR/RFID tag and reports nearby carts to the server 24, and wherein the store server knows which device is nearby from the database.

Since the system can identify the location of the cart 16, and therefore by extension may identify the location of the store customer via the customer's mobile device 14, the system may present the customer with information about nearby items. The customer can load filters into the store application stored and executed at the mobile device 14 to configure received information to be more relevant to the customer's needs and interests. For example, the mobile device store application may be configured to filter information by price, dietary needs, and so on. For example, if a customer is diabetic, the customer may not be interested in sugary cereals. Filters can be implemented that would allow any advertisements and promotions to be more relevant and effective to the customer's needs.

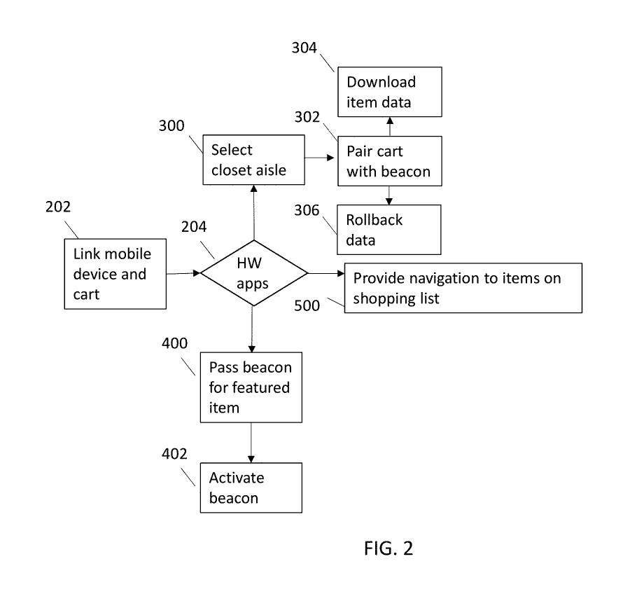

FIG. 2 is a flow diagram of elements of a system for promoting store items, in accordance with some embodiments. In describing the elements of FIG. 2, reference is made to FIG. 1.

At block 202, the mobile device 14 and shopping cart 16 are linked, or paired, for example, similar to step 101 shown in FIG. 1. For example, a user may connect a mobile device 14 to a shopping cart 16 by scanning a QR code or the like on the cart 16 with a mobile device scanning device. This scanning step will link to a computer chip in the cart 16, for example, the IoT device 15, which includes a WiFi or RFID transmitter/receiver or the like, geofencing device, and/or IR beacon processor for communicating with other electronic devices of the environment of FIG. 1. In some embodiments, the shopping cart 16 may be electronically paired with a gaming application executed on the mobile device 14.

At decision diamond 204, a set of possible hardware applications are identified. A first application (300) is that the customer may use the mobile device application 21 to select a closest aisle or other location detected by the shopping cart IoT device 15. A second application (400) is where the shopping cart 16 passes a beacon 13 or other detector corresponding to a location where a promotion may occur for a featured item. A third application (500) may be related to a customer creating a shopping list that is stored electronically and executed at the mobile device 14. The IoT device 15 at the cart 176 can provide navigational services, for example, directing the customer to the items on the shopping list using IR beacons 13 or other sensors.

When an aisle beacon sees a nearby cart, it reports to the location of the cart within the store. Once we know where the cart is, the store can send information relevant of that area of the store to the mobile device 14.

Referring to the first application 300, an aisle or other location closest to the customer may be established by the nearest aisle beacon 13 outputting signals to locate nearby shopping carts 16. When the aisle beacon 13 identifies a cart, it reports the location of the cart to the store server 24 which can process the location information and in response output information relevant to that region of the store.

Thus, when the shopping cart 16 is detected, the cart 16 automatically associates, or pairs (302), with the nearest aisle beacon 13, for example, similar to step 102 of FIG. 1. In doing so, the mobile device store application executed at the customer's mobile device 14 which in turn is paired with the identified cart 16 may display information relevant to the region of the store where the customer is currently located. The information may be retrieved (304), i.e., downloaded, from a data repository, for example, store database 25 illustrated and described in FIG. 1. For example, location and/or item information, for example, information about items at the aisle 12 may be downloaded (304) to the mobile device 14 from the store database 25. A user may select from the mobile device 14 item information such as item types, search options, and other item information. For example, the mobile device 14 may display a “search by option” feature, for example, item information for a featured promotion such as brand, description, price, customer ratings and reviews, and dietary information. After an item is selected from a list displayed at the mobile device 14, the foregoing examples such as brand, description, and so on may be displayed regarding the selected item.

In other embodiments, when a location closest to the customer is selected (300), and the shopping cart 16 is paired (302) with the nearest aisle beacon 13, a rollback option (306) may be generated. Here, the customer may be offered access to special features within the application 21. These features could include access to special application-only promotions such as coupons or rollback information and item information such as brand, description, price, and so on. When activated, the rollback feature may trigger the mobile device application to display items in the selected or closest aisle or other location of interest to be displayed that have a special price offer or other rollback price. The user may select such items from a list and in response receive item information such as brand, description, consumer ratings, and so on.

Referring again to the second application (400) where the shopping cart 16 passes a beacon 13 or other detector corresponding to a location where a promotion may occur for a featured item. A detection device such as a beacon 13 may be at the location in the store where item promotions may occur. As a detection device, the beacon 13 may be activated due to a detection of the cart 16 in proximity of the beacon 13 may trigger an electronic game, details of which may be stored (205) at a customer database 46. Location and/or item information, for example, information about items at the aisle 12 may be exchanged, and stored (203) at the store database 25. After the customer location is determined by the system, relevant information about that location can be processed, and used as part of the game.

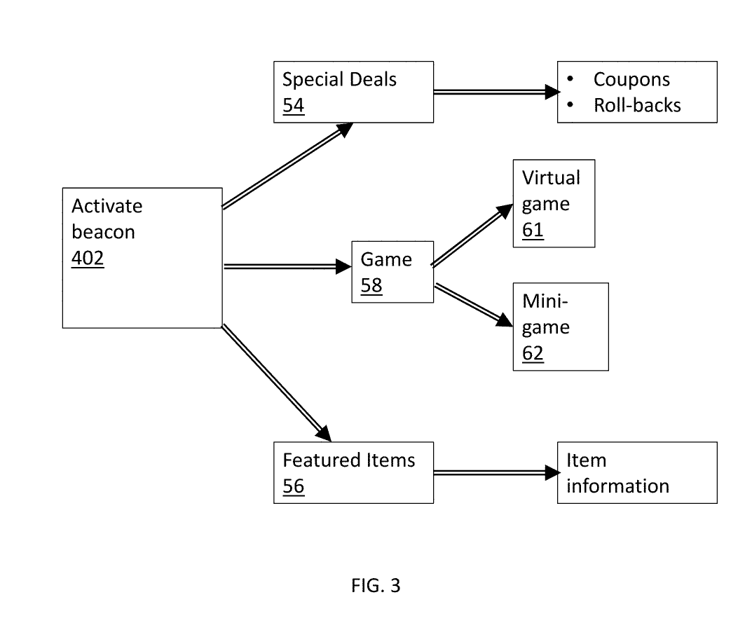

FIG. 3 is a flow diagram of elements of a system for promoting store items based on a shopper's location, in accordance with some embodiments. In describing the elements of FIG. 3, reference is made to FIGS. 1 and 2. The flow diagram steps in FIG. 3 may occur after a beacon 13 is activated (402) described in FIG. 2.

In some embodiments, a customer moving a shopping cart 16 allows the customer access to special features as part of the store application 21 executed by the customer's mobile device 14. For example, the shopping cart 16 may pass by a beacon 13 that is indicative of a featured store item at the aisle 12. As described in step 402 in FIG. 2, the beacon 13 may activate when the shopping cart 16 is detected. In some embodiments, the shopping cart 16 passes near a promotional IR or RFID beacon 13 that allows the customer access to special features that may be executed by the application 21. These features could include access to special application-only promotions 54 such as coupons or rollback information and item information 56 such as brand, description, price, and so on.

When the beacon 13 for the featured item 56 is activated, promotional information may be exchanged. For example, an IR beacon may mark on the application 21 where current promotions, or special deals 54 such as coupons, rollback information and so on can be obtained via the shopping cart 14. The store server 24 can send relevant information 54 about rollbacks and promotions to the application based on the location, which may be displayed via the application as notifications. As previously mentioned, promoted items 56 of interest may have corresponding item information may include for a feature promotion one or more of brand, description, price, customer ratings and reviews, and dietary information which can be obtained. This information may be retrieved from QR codes or other encoded data, which can be scanned by the mobile device 14. Alternatively, the information is retrieved automatically after the customer location is detected by the beacon 13, whereby information relevant to the location is retrieved and used as part of an electronic game 58.

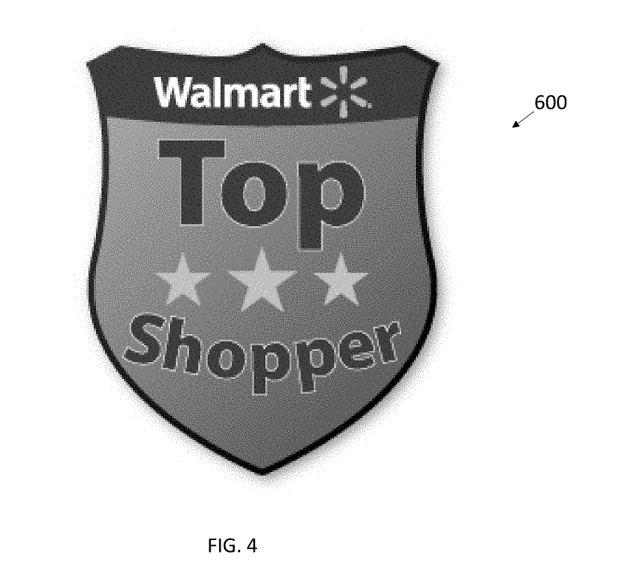

In some embodiments, the game 58 is an augmented reality gaming application, where the customer may receive information about the promoted item, a current location of the user, and/or other store-related information while augmenting the real world shopping experience with a sensory input such as sound, video, graphics, and or GPS data in the forming of a gaming application. Here, a customer may add an interactive, or digital, gaming experience to a real-world shopping experience. The game 58 may be developed by a first party or sponsored second party such as a vendor, manufacturer, or other business entity conducting commercial transactions with the store. The game 58 may be downloaded to the mobile device 14, and executed by the application 21 to play offline. In some examples, the user may be rewarded for completing the game 58 or winning the game 58 or otherwise meeting or exceeding a metric set forth in the game 58. A reward may include a badge, or points, discount, other incentives, for example, a virtual badge 600 illustrated at FIG. 4.

During operation of a game, a user may be rewarded points based on a combination of factors. Based on the time efficiency of their shopping experience. Getting through the list fast may be preferable, but would be relative to the difficulty of their list. For example, a list with two items in at the front of the store would have a low difficulty and not result in many points. Long, complex lists with items throughout the store would take longer, but reward users more.

Based on savings from discounted and promoted items. When the user saves money, they get extra points. Example: When buying items on a rollback offering. More discount off retail price=more points.

Promoted items throughout the store would trigger a pop-up when the user is a predetermined distance from the promoted items, for example, detected by geofencing, WiFi, or other navigation or detection technology. The user is prompted to add the item to a discount card or the like or pass by. If added to the cart, the customer is rewarded by bonus points and/or sharable “badges” for social sharing.

Store could designate several random items as “hidden treasures.” These items would not be advertised or promoted as such. However, when added to a user's cart, they would be told that they found a “hidden treasure.” This hidden treasure would reward the customer with a coupon they could use on another item in the store (likely a promoted item). For example, Great Value Peanut Butter may be referred to as a hidden treasure in a store. When the user adds an electronic representation of the hidden treasure, the user may be informed via a display of this, and provided a digital coupon, for example, 40% off a tube of toothpaste. As with many games, the more users play, the more coupons/badges/rewards they receive. Another example of a game may include a “quest” where the goal of the game is to search for store items of interest, while the system executes navigation technology in the store to direct the user during the quest to promoted items.

When a customer is in proximity of the item of interest in the aisle, a small sprite, image, icon, or other electronic representation of the item may be displayed, for example, on a map that serves as a treasure map of the like, allowing the customer to tap on it and open up a barcode scanner or view further information on the item. To achieve this, the customer's shopping list is loaded onto the mobile device application 21 executed at the mobile device 14.

Each store may post a leaderboard on a display near the front of the store. The display may display a list of the top scoring users. Top users may receive extra privileges and promotions. For example, the top scorer for a store could be the store's “all-star” shopper. The all-Star shopper may receive an award such as a discount on every item in the store while they maintain the top spot. The leaderboard when electronically stored and executed at a computer may be accessible online and sharable on social media.

Badges or related awards may be collected at the store application 21, and shared via social media or other network-related communication. The exchange of badges or the like in this manner may promote an item brand while also encouraging the customer to pursue additional badges or the like. In some cases, a game may not be available. Badges can be awarded by winning games, purchasing certain items, or locating certain promotions throughout the store. These virtual badges, e.g., shown in FIG. 4, can be given away or awarded by the store through any type of promotion which they may wish to award a small prize for, thus encouraging the customers to participate in more of a store's promotions.

A game may be stored within a badge, and played offline. For example, in order to obtain a badge 600, a customer must complete a short game on their device. If the customer wishes to replay a game after completing the game, then the customer may select the badge 600 that has been awarded to the customer and may be presented with the option to replay said game. For example, a customer may not wish to play the game in the middle of a grocery store aisle where items of interest are located, and may select an option to play it later, and may be provided electronically a temporary placeholder badge which will grant the customer the reward after completing the game.

Items that have special promotions may include QR codes or the like for the badge or game. A QR code may be provided in an advertisement, for example, a paper or circular advertisement or electronic advertisement. This may encourage customers to pick up a circular while informing them where they may go to find their virtual badge 61 and/or mini-game 62. For example, a customer may open up the circular advertisement or the like and notice that an advertisement regarding an item of interest such as a box of cereal has a QR code beside it. The customer can use a mobile device 14 to scan this QR code and in response receive a displayed notification that there is a promotion for the particular type of cereal of interest. A game may be offered were the customer must select flakes, grains, or other elements of cereal that are displayed as “falling from the sky,” which requires user dexterity to select as many elements as possible from the user interface. If the customer selects a predetermined number of elements within a predetermined amount of time, then the customer is presented with a virtual badge 600. In another example, the customer may receive a notification that if the customer purchases a box of the cereal within a predetermined amount of time, e.g, one week, then the user may receive a “cereal badge” to display on the customer's social media profile.

A virtual game 61 or badge 600 may include games stored at and executed by at least one special purpose hardware computer processor, where badges are collected from a first party such as the store offering the items for sale and promoting the ability to play electronic games in connection with a shopping experience. Earned virtual badges may be stored at the customer's store account. A user may connect to social media and share collected pins on social media. Referring again to the previous cereal example, after the user selects a predetermined number of elements within a predetermined amount of time, and presented with a virtual badge 600, the user can share the experience with social network friends or others connected by social media. The awarded badge may offer the option to be shared on a social media account, along with messages such as “I caught 52 corn flakes in 30 seconds” and/or promotional information, for example, an invitation to play the game. In some embodiments, this may be triggered by the user's location in the store, for example, a location relative to the cereal aisle in the store.

A mini-game 62 may include either a second party or a first party. A second party promotion from an advertiser who is sponsoring a promotion or a mini-game may be created by a first party developer and offered by the first party.

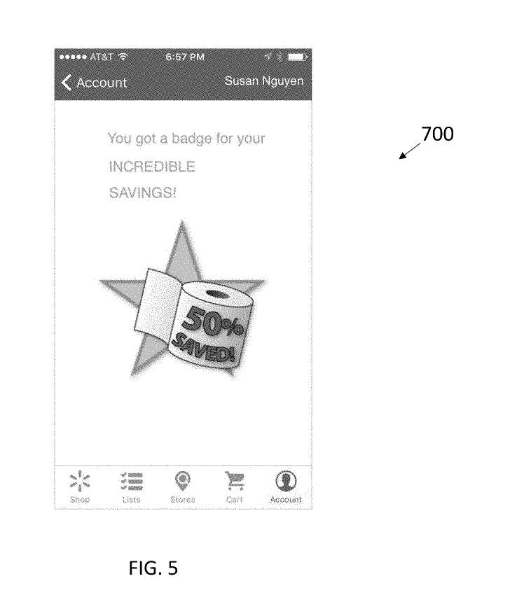

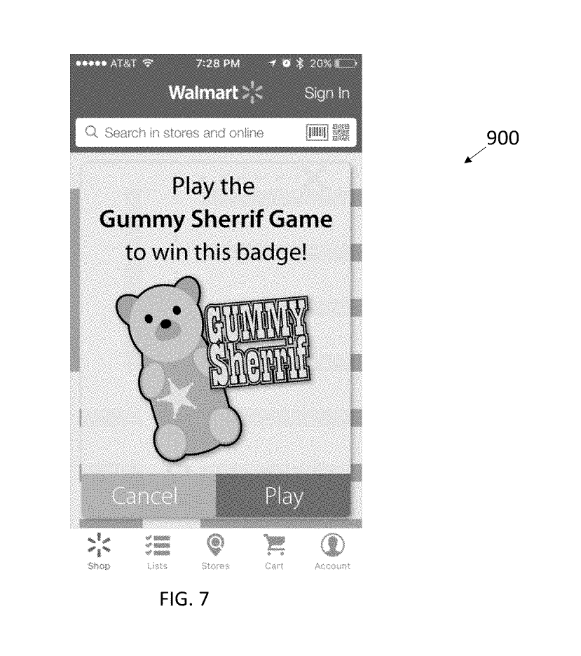

In one example, a store may promote a particular candy. When a customer using a shopping cart 16 passes by the promotional display with an IR or RFID beacon, the customer may receive a “virtual candy badge” on a customer profile, for example, shown at the screenshot of the display 700 of FIG. 5, and could share it on social media, if a social media account is linked. For example, as shown in FIG. 7, a shareable social media image 900 is used by the gaming application to generate a promotional message. A store may include a storage device for storing customer profile data for capturing purchase information or other customer data. Some or all of this data may be used for a customer who receives a badge, for example, after winning a game. For example, a customer may receive a sales promotion on toilet paper and wishes to share this exciting information with her friends. She can link to their store customer profile which will display more information on the great deals they have obtained through a collection of virtual badges.

An example of a mini-game, or sub-game as part of a larger game, may be a cereal company desiring to promote cereal be providing a gaming application for use by shoppers. Here, a mini-game may be initiated, activated, or otherwise triggered based on the user's presence relative to the cereal of interest, for example, using geofencing, WiFi triangulation, or other location detection technology described in embodiments herein. The mini-game may be part of a shopping application or the like executed by the user's smartphone or other computing device. The mini-game may be used by the shopper to earn points or other incentives, which may be applied to a larger game, or directly processed by the shopping application so that the user can receive a discount or other value by the point of sale system of the store.

The system may provide a short game for a child to play. Not only would this be exciting for the child, but could spark interest for the parent in the product as well. The game would continue to be available even when the customer and their child have moved away from the display. While the child is playing, the customer can receive coupons through the application or learn more information about the product and see how other customers rate and review the product.

In another example, a customer may decide which cereal she wishes to purchase. The customer prefers a cereal that is between $2 and $5, has less than 200 calories per serving and does not have sugar due to diabetes. Based on the customer's proximity to the nearest aisle beacon, the customer could choose from available search options and find items which match their criteria. Once they select one of these items, the customer would be able to view more information about these items and how to locate them.

In another example, the customer's device 14, when paired with a shopping cart 16, could scan items that the customer is interested in purchasing. The customer could then place the items into a special area of the cart that would weigh items. At the end of the shopping trip, the user's device would interact with the cart to use Walmart Pay. User would not have to carry a portable scan-n-go, as their phone would scan the item and store the list in the Walmart app. At the end of the trip, the user would use a point of sale feature, for example, expedited payment, to check out. This would cut down on the physical items needed for a shopping trip/checkout and could even cut out physical checkout, making a quick and seamless shopping experience via their shopping cart 16.

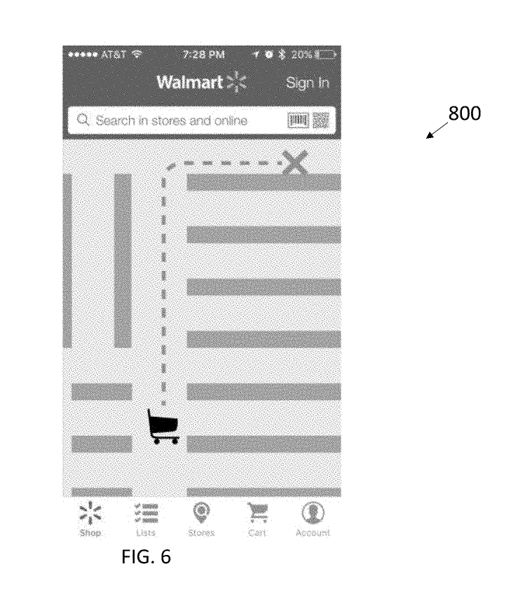

Another feature may permit the customer to input a shopping list remotely from the store, for example, from a home computer. This may synchronize with items available in the store and provide the user with navigational functionality within the store using the IR or RFID beacons to guide the cart to the desired items. If a customer builds a shopping list at home or on their device, the customer can navigate to it via the cart's in-store location. For example, a location detector such as a beacon or the like may provide a location of a customer in the store. The customer may receive and follow prompts on the mobile device 14 to find the item of interest. The shopping list is entered into the application 21, or more specifically, user's store account. The completed shopping list may trigger the starting point of a game in some embodiments. The gaming application permits a user to search for items of interest as a game objective, wherein the pairing includes a navigation feature that guides the user to promoted items during the game play, for example, shown in the screenshot of the display 800 shown in FIG. 6.

The system may be available on non-promotional endcaps and could include information about what is contained on that aisle. For example, the information may include types of items, allowing a customer the option to search for specific products by brand, dietary needs, calorie intake, sugar content, special dietary needs, and so on. Once the customer locates the item of interest, the customer can select it on a display to view other information on the product such as brand, product description, price, and so on. The application may also have a feature offering customers the ability to see rollback information available on items within the aisle. It would also allow them to access item information as mentioned above when the item is selected.

The foregoing method steps may include the storing of program code in a computer-readable storage device of the computer system through use of the processor. The program code, upon being executed by the processor, implements a method according to embodiments herein. Thus, the present invention discloses a process for supporting, deploying and/or integrating computer infrastructure, integrating, hosting, maintaining, and deploying computer-readable code into one or more computer devices, wherein the code in combination with the computer device is capable of performing a method according to embodiments herein.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for promoting store items at a retail environment, comprising:
electronically pairing an augmented-reality gaming application, executed on a mobile electronic device with a shopping cart;
determining a location of the shopping cart;
establishing an electronic communication between the gaming application and the shopping cart during a shopping cart user's presence in the retail environment;
receiving data at the mobile electronic device pertaining to a store item promotion in response to determining the location of the shopping cart; and
applying information regarding the location of the shopping cart to the gaming application.

2. The method of claim 1, wherein determining the location of the shopping cart includes:
detecting, by a detection device at the retail environment, the shopping cart;
reporting, by the detection device, to a store computer the location of the shopping cart; and
outputting, by the store computer, information relevant a region of the retail environment that includes the location of the shopping cart.

3. The method of claim 1, wherein the shopping cart includes an Internet of Things (IoT) device that provides a combination of wireless fidelity (WiFi), geofencing, and an infrared (IR) beacon.

4. The method of claim 3, wherein the IoT device further includes a digital scale.

5. The method of claim 1, wherein pairing the application and the shopping cart comprises scanning a quick response (QR) code on the shopping cart that identifies the shopping cart.

6. The method of claim 1, detecting the shopping cart by establishing a communication between beacons at the retail environment and a receiving tag at the shopping cart.

7. The method of claim 6, wherein detecting the shopping cart includes broadcasting by the beacons an infrared (IR) or radio frequency identification (RFID) signal for receipt by the receiving tag at the shopping cart.

8. The method of claim 1, wherein detecting the shopping cart includes:
establishing an electronic communication between a promotional display at the retail establishment and the shopping cart; and
receiving promotional feature data at the mobile electronic device.

9. The method of claim 8, wherein the retail establishment includes a location beacon device, and wherein the method further comprises:
scanning for the shopping cart when the shopping cart is within a predetermined distance from the location beacon device;
notifying by the location beacon device a store server when the cart has entered a geofence establishing the predetermined distance;
sending by the server a promotional message to the linked mobile device that corresponds to the location beacon device; and
prompting the user with the promotional message.

10. The method of claim 8, wherein a shareable social media image is used by the gaming application to generate the promotional message.

11. The method of claim 10, further comprising providing coupons to the application while the game is being played.

12. The method of claim 1, wherein the game is used to provide a reward.

13. The method of claim 1, further comprising executing a shopping list electronically prior to executing the gaming application.

14. The method of claim 13, wherein the shopping list is entered to the application or retrieved by the mobile electronic device from a remote storage location.

15. A virtual promotion generation system, comprising:
an application executed by a mobile electronic device; and
a shopping cart electronically paired with the application so that in response to the pairing, promotion data is provided to the mobile electronic device.

16. The system of claim 15, wherein the shopping cart comprises a quick response (QR) code that identifies the shopping cart.

17. The system of claim 15, wherein the shopping cart further comprises an infrared (IR) or radio frequency identification (RFID) tag that establishes a location of the shopping cart, such that when the QR is scanned for the cart, the user's device reports the cart number to a store server, wherein the store server keeps a database of cart/device pairings. And wherein a beacon actively scans and detects the IR/RFID tag and reports nearby carts to the server, and wherein the store server knows which device is nearby from the database.

18. The system of claim 15, wherein the shopping cart comprises a digital scale to weigh items when scanned to the shopping cart.

19. The system of claim 15, wherein the application communicates with a Wi-Fi network for receiving the promotion data.

20. The system of claim 15, further comprising a digital shopping list executed at the mobile electronic device.

21. The system of claim 15, wherein the gaming application permits a user to search for items of interest as a game objective, wherein the pairing includes a navigation feature that guides the user to promoted items during the game play.
